(19) United States
(12) Patent Application Publication
(10) Pub. No.: US 2018/0173049 A1
(43) Pub. Date: Jun. 21, 2018

(54) METAL WIRE GRID POLARIZER AND LIQUID CRYSTAL DISPLAY DEVICE

(71) Applicant: Wuhan China Star Optoelectronics Techology Co., Ltd, Wuhan, Hubei (CN)

(72) Inventor: Guowei Zha, Wuhan City (CN)

(21) Appl. No.: 15/119,379

(22) PCT Filed: Jun. 23, 2016
(86) PCT No.: PCT/CN2016/086851

§ 371 Date: Aug. 16, 2016

(30) Foreign Application Priority Data
Jun. 8, 2016 (CN) 201610402079.X

(51) Int. Cl. G02F 1/1335; G02B 5/30; G02F 1/1333; G06F 3/041

(52) U.S. Cl. CPC G02F 1/133528; G02B 5/30; G02F 1/13338; G02F 2001/133548; G02F 1/133512; G02F 1/133602; G06F 3/0412

(57) ABSTRACT

The present invention provides a metal wire grid polarizer and a liquid crystal display device. The metal wire grid polarizer of the present invention comprises a metal light-shielding frame arranged on an outer circumference of a polarization zone so as to reduce the potential risk of peripheral light leakage of a liquid crystal display device when the metal wire grid polarizer is used to substitute an upper polarizer of the liquid crystal display device, thereby helping reduce the width of a light-shielding zone on a periphery of a touch screen to facilitate bezel narrowing of the liquid crystal display device. The liquid crystal display device of the present invention uses the metal wire grid polarizer to substitute a conventionally-used upper polarizer to reduce the potential risk of peripheral light leakage thereby helping reduce the width of a light-shielding zone on a periphery of a touch screen to facilitate bezel narrowing of the liquid crystal display device.

### BACKGROUND OF THE INVENTION

### 1. Field of the Invention

The present invention relates to the field of display technology, and in particular to a metal wire grid polarizer and a liquid crystal display device.

### 2. The Related Arts

With the progress of the display technology, flat panel display devices, such as liquid crystal displays (LCDs), due to a variety of advantages, such as high image quality, low power consumption, thin device body, and wide applications, have been widely used in all sorts of electronic consumer products, such as mobile phones, televisions, personal digital assistants (PDAs), digital cameras, notebook computers, and desktop computers, and become the main stream of display devices.

Most of the liquid crystal display devices that are currently available in the market are backlighting LCDs, which comprise a liquid crystal display panel and a backlight module. The working principle of the liquid crystal display panel is that liquid crystal molecules are disposed between two parallel glass substrates and multiple vertical and horizontal tiny wires are arranged between the two glass substrates so that through application of electricity to control the liquid crystal molecules to change direction in order to refract out light emitting from the backlight module to generate an image

The liquid crystal display panel generally comprises a color filter (CF) substrate, a thin-film transistor (TFT) substrate, liquid crystal (LC) interposed between the CF substrate and the TFT substrate, and sealant.

When the liquid crystal displays are used in hand-held devices, which are generally of a small size, people have increasing demands for light weight and small bezel of the display devices and these devices face direct competition by organic light emitting diode (OLED) displays in these respects. Bezel narrowing for the liquid crystal display faces limitations imposed by the manufacturing operations and also suffers the potential risk of light leakage. As shown in FIG. 1 a conventional liquid crystal display device is shown, comprising a touch screen 100, a liquid crystal display panel 200, an upper polarizer 300, a lower polarizer 400, and a backlight module 500, wherein the backlight module 500 comprises a black/white adhesive tape 510, a brightness enhancement film 520, a diffusion film 530, a light guide plate 540, a light emitting diode (LED) light (not shown), a reflection film 560, and a white module frame 570. As shown in FIG. 2, light from the backlight module 500, besides irradiating a display zone (AA zone) of the liquid crystal display panel 200, may get leaking through the peripheral white mold frame 570. The leaking light, when encountering a reflecting surface, particularly a metal-made phone intermediate frame 600, shows apparent light leaking in the top side so that it often needs to provide a shielding zone 110 on the periphery of the touch screen 100 to prevent the light leakage.

Since the liquid crystal display panel 200 is provided, on an underside thereof, with the black/white adhesive tape 510 and since the liquid crystal display panel 200 is provide, on an internal circumference thereof, with a black matrix 800, leaking light from the backlight module 500 may only be reflected by the phone intermediate frame 600 to the light shielding zone 110 on the periphery of the touch screen 100 to cause touch screen peripheral light leaking. Total internal reflection at an interface between a glass substrate of the touch screen and air prevents light having an incident angle that is greater than θ=arcsin(1/n_{glass}) (where n_{glass}, the refractive index of glass) from glass is escaping from the surface of the touch screen 100 so as not to cause light leakage. Thus, theoretically, an edge margin of the touch screen 100 must have a minimum light shielding distance d (meaning a width of the light shielding zone 110), which must satisfy d≥h*tan θ, in order to eliminate the potential risk of light leakage, where h is the sum of the thicknesses of an upper substrate 210, an upper polarizer 300, and bonding adhesive 900. It is common to make d greater than 0.5 mm, or even 0.7 mm. However, with the increasing demand for bezel narrowing, this becomes hardly acceptable. With the progress of the LCD narrow bezel technology, the width d of the touch screen light shielding zone 110 for various products has been reduced to 0.5 mm, or even 0.4 mm. Under such a condition, leaking light from the backlight module 500 would pass through structures of such as the upper polarizer 300, to leak to the periphery of the touch screen 100, demonstrating apparent bezel light leakage (as shown in FIG. 2).

### SUMMARY OF THE INVENTION

An object of the present invention is to provide a metal wire grid polarizer, which reduces the potential risk of peripheral light leaking of a liquid crystal display device to facilitate bezel narrowing of the liquid crystal display device.

Another object of the present invention is to provide a liquid crystal display device, which involves a metal wire grid polarizer to substitute a conventionally used upper polarizer in order to reduce the potential risk of peripheral light leaking and thus help reduce the width of a light shielding zone on a periphery of a touch screen to facilitate bezel narrowing of the liquid crystal display device.

To achieve the above objects, the present invention provides a metal wire grid polarizer, which comprises a dielectric layer and a metal layer arranged on the dielectric layer. The metal layer comprises a plurality of metal wire grid units sequentially arranged side by side and a metal light-shielding frame arranged along an outer circumference of the plurality of metal wire grid units. The metal wire grid units each comprise a metal strip and a strip-shaped space arranged at one side of the metal strip. The plurality of metal wire grid units provides a function of polarization. The metal light-shielding frame provides a function of shielding light.

The metal wire grid units each have a width of 20-500 nm; the metal strips each have a width that is of a ratio of 0.1-0.9 of the width of the metal wire grid units; and the metal strips have a thickness of 10-500 nm.

The metal layer is formed of a material comprising one or multiple ones of aluminum, silver, and gold; and the dielectric layer is formed of a material comprising one or multiple ones of silicon dioxide, silicon monoxide, magnesium oxide, silicon nitride, titanium dioxide, and tantalum pentoxide.

The metal light-shielding frame is a rectangular frame, which comprises two first metal bands that are opposite to each other and two second metal bands that are respectively connected to two ends of each of the two first metal bands. The first metal bands and the second metal bands have widths of 0.1-1 mm.

The metal light-shielding frame is connected to two ends of each of the metal strips of the plurality of metal wire grid units; and the metal light-shielding frame and the plurality of metal wire grid units are integrally formed as a unitary structure.

The present invention also provides a liquid crystal display device, which comprises, in sequence from bottom to top, a backlight module, a lower polarizer, a liquid crystal display panel, a metal wire grid polarizer, and a touch screen;

wherein the metal wire grid polarizer comprises a dielectric layer and a metal layer arranged on the dielectric layer, the metal layer comprising a plurality of metal wire grid units sequentially arranged side by side and a metal light-shielding frame arranged along an outer circumference of the plurality of metal wire grid units, the metal wire grid units each comprising a metal strip and a strip-shaped space arranged at one side of the metal strip, the plurality of metal wire grid units providing a function of polarization, the metal light-shielding frame providing a function of shielding light.

The metal wire grid units each have a width of 20-500 nm; the metal strips each have a width that is of a ratio of 0.1-0.9 of the width of the metal wire grid units; and the metal strips have a thickness of 10-500 nm.

The metal layer is formed of a material comprising one or multiple ones of aluminum, silver, and gold; and the dielectric layer is formed of a material comprising one or multiple ones of silicon dioxide, silicon monoxide, magnesium oxide, silicon nitride, titanium dioxide, and tantalum pentoxide.

The metal light-shielding frame is a rectangular frame, which comprises two first metal bands that are opposite to each other and two second metal bands that are respectively connected to two ends of each of the two first metal bands. The first metal bands and the second metal bands have widths of 0.1-1 mm.

The liquid crystal display device further comprises a mold frame arranged on an outer circumference of the backlight module, a light-shielding adhesive tape that is adhesively attached to an edge of a lower surface of the lower polarizer, an edge of an upper surface of the backlight module, and a top surface of the mold frame, and an intermediate frame arranged at a lateral side of the liquid crystal display panel and the backlight module;

wherein the liquid crystal display panel comprises an upper substrate and a lower substrate that are opposite to each other, liquid crystal arranged between the upper substrate and the lower substrate, and a light-shielding layer arranged on a peripheral area of the upper substrate or the lower substrate; and

the touch screen has a peripheral area on which a light-shielding zone is provided.

The present invention further provides a liquid crystal display device, which comprises, in sequence from bottom to top, a backlight module, a lower polarizer, a liquid crystal display panel, a metal wire grid polarizer, and a touch screen;

wherein the metal wire grid polarizer comprises a dielectric layer and a metal layer arranged on the dielectric layer, the metal layer comprising a plurality of metal wire grid units sequentially arranged side by side and a metal light-shielding frame arranged along an outer circumference of the plurality of metal wire grid units, the metal wire grid units each comprising a metal strip and a strip-shaped space arranged at one side of the metal strip, the plurality of metal wire grid units providing a function of polarization, the metal light-shielding frame providing a function of shielding light;

the liquid crystal display device further comprising a mold frame arranged on an outer circumference of the backlight module, a light-shielding adhesive tape that is adhesively attached to an edge of a lower surface of the lower polarizer, an edge of an upper surface of the backlight module, and a top surface of the mold frame, and an intermediate frame arranged at a lateral side of the liquid crystal display panel and the backlight module;

wherein the liquid crystal display panel comprises an upper substrate and a lower substrate that are opposite to each other, liquid crystal arranged between the upper substrate and the lower substrate, and a light-shielding layer arranged on a peripheral area of the upper substrate or the lower substrate; and

the touch screen has a peripheral area on which a light-shielding zone is provided;

wherein the metal layer is formed of a material comprising one or multiple ones of aluminum, silver, and gold; and the dielectric layer is formed of a material comprising one or multiple ones of silicon dioxide, silicon monoxide, magnesium oxide, silicon nitride, titanium dioxide, and tantalum pentoxide.

The efficacy of the present invention is that the present invention provides a metal wire grid polarizer and a liquid crystal display device. The metal wire grid polarizer of the present invention comprises a metal light-shielding frame arranged on an outer circumference of a polarization zone so as to reduce the potential risk of peripheral light leakage of a liquid crystal display device when the metal wire grid polarizer is used to substitute an upper polarizer of the liquid crystal display device, thereby helping reduce the width of a light-shielding zone on a periphery of a touch screen to facilitate bezel narrowing of the liquid crystal display device. The liquid crystal display device of the present invention uses the metal wire grid polarizer to substitute a conventionally-used upper polarizer to reduce the potential risk of peripheral light leakage thereby helping reduce the width of a light-shielding zone on a periphery of a touch screen to facilitate bezel narrowing of the liquid crystal display device.

For better understanding of the features and technical contents of the present invention, reference will be made to the following detailed description of the present invention and the attached drawings. However, the drawings are provided for the purposes of reference and illustration only and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing.

In the drawing:

FIG. 1 is a schematic view illustrating the structure of a conventional liquid crystal display device;

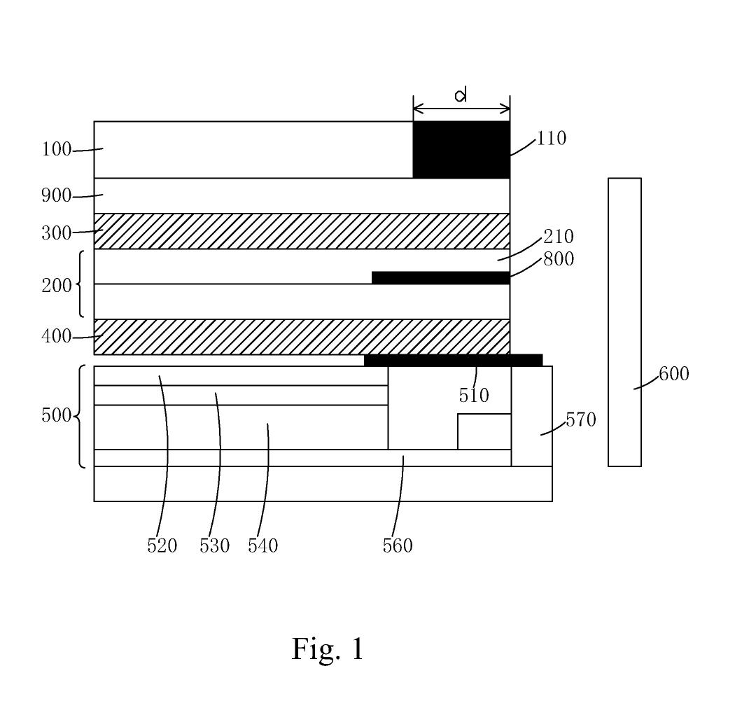

FIG. 2 is a schematic view illustrating light leakage occurring in the conventional liquid crystal display device;

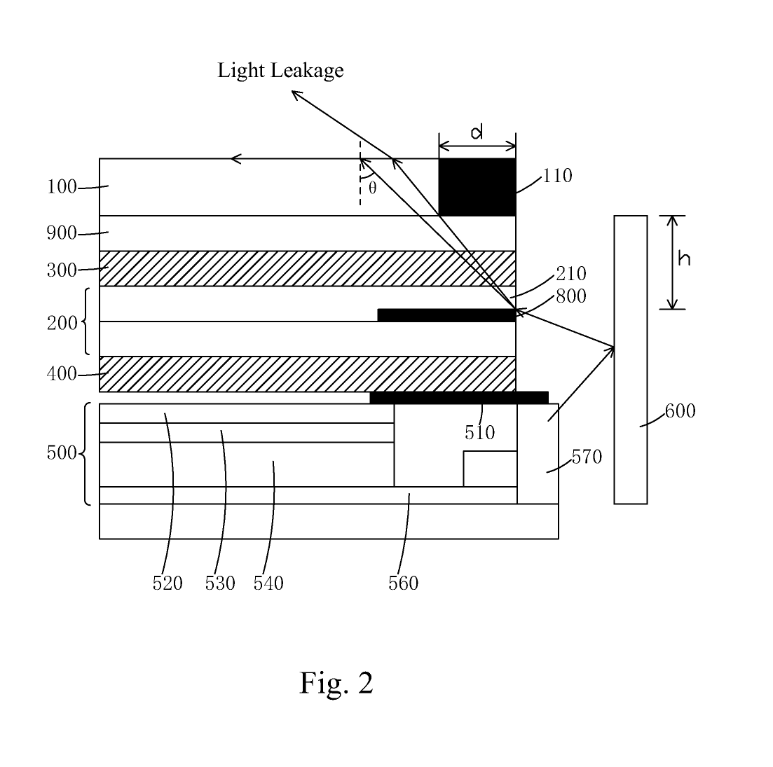

FIG. 3 is a cross-sectional view illustrating a metal wire grid polarizer according to the present invention;

FIG. 4 is top plan view showing a first embodiment of the metal wire grid polarizer of the present invention;

FIG. 5 is top plan view showing a second embodiment of the metal wire grid polarizer of the present invention; and

FIG. 6 is a schematic view illustrating a structure of a liquid crystal display device according to the present invention.

### DETAILED DESCRIPTION OF THE PREFERRED EMBODIMENTS

To further expound the technical solution adopted in the present invention and the advantages thereof, a detailed description is given to a preferred embodiment of the present invention with reference to the attached drawings.

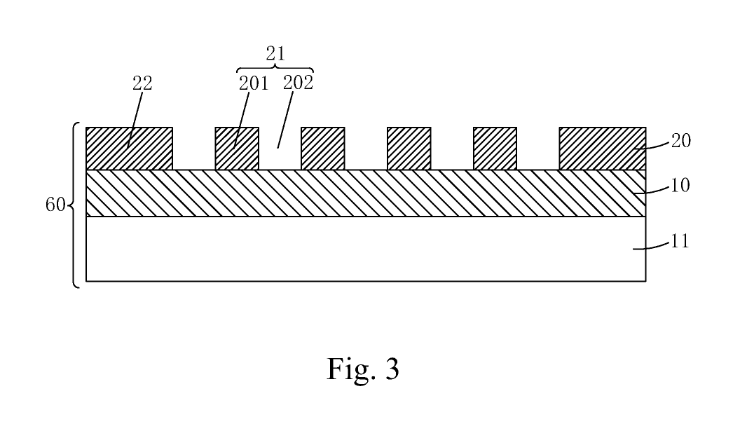

Referring to FIGS. 3-5, firstly, the present invention provides a metal wire grid polarizer 60, which comprises a dielectric layer 10 and a metal layer 20 arranged on the dielectric layer 10. The metal layer 20 comprises a plurality of metal wire grid units 21, which are sequentially arranged side by side, and a metal light-shielding frame 22 arranged along an outer circumference of the plurality of metal wire grid units 21. The metal wire grid units 21 each comprise a metal strip 201 and a strip-shaped space 202 arranged at one side of the metal strip 201. The plurality of metal wire grid units 21 provides a function of polarization, while the metal light-shielding frame 22 provides a function of shielding light.

In the metal wire grid polarizer 60, the plurality of metal wire grid units 21 collectively form a polarization zone, which allows polarized light having a polarization direction perpendicular to the metal strips 201 to transmit and reflects polarized light having a polarization direction parallel to the metal strips 201 in order to achieve the function of polarization. The metal light-shielding frame 22 provides the function of shielding light and helps prevent light leakage at a periphery of a liquid crystal display device so as to facilitate bezel narrowing of the liquid crystal display device.

Specifically, the metal light-shielding frame 22 is connected to two ends of each of the plurality of metal strips 201 of the plurality of metal wire grid units 21. Preferably, the metal light-shielding frame 22 and the plurality of metal wire grid units 21 are integrally formed as a unitary structure.

Specifically, the metal wire grid units 21 each have a width of 20-500 nm, and the metal strip 201 has a width that is of a ratio of 0.1-0.9 of the width of the metal wire grid units 21. The metal strips 201 have a thickness of 10-500 nm. The metal light-shielding frame 22 has a thickness that is identical to the thickness of the metal strips 201.

Specifically, the metal layer 20 is formed of a material that comprises a metal material having a relatively large imaginary part of refractive index, such as one of multiple ones of aluminum (Al), silver (Ag), and gold (Au).

Specifically, the dielectric layer 10 has a thickness of 10-1000 nm.

Specifically, the dielectric layer 10 is formed of a material comprising one or multiple ones of silicon dioxide (SiO₂), silicon monoxide (SiO), magnesium oxide (MgO), silicon nitride (Si₃N₄), titanium oxide (TiO₂), and tantalum pentoxide (Ta₂O₅).

Specifically, the metal light-shielding frame 22 is a rectangular frame, which comprises two first metal bands 221 that are opposite to each other and two second metal bands 222 that are respectively connected to two ends of each of the two first metal bands 221. The first metal bands 221 and the second metal bands 222 have widths of 0.1-1 mm.

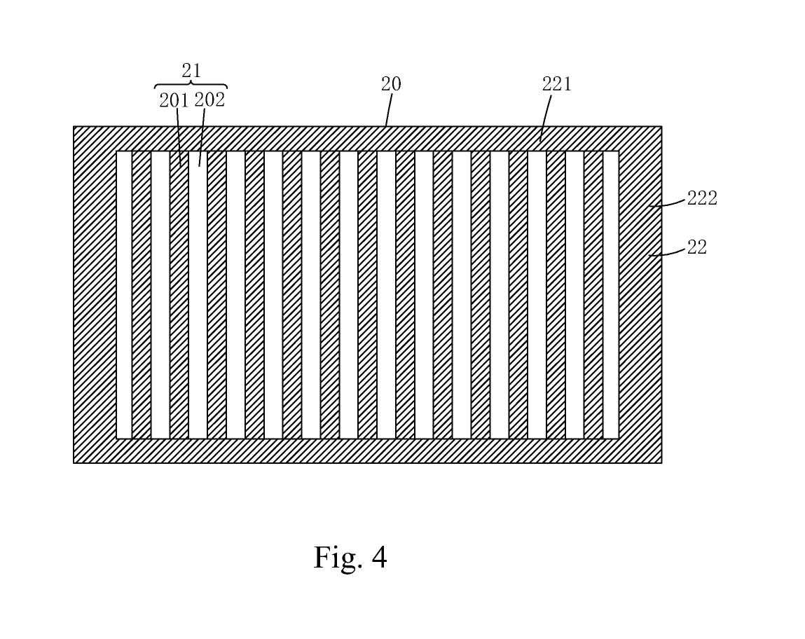

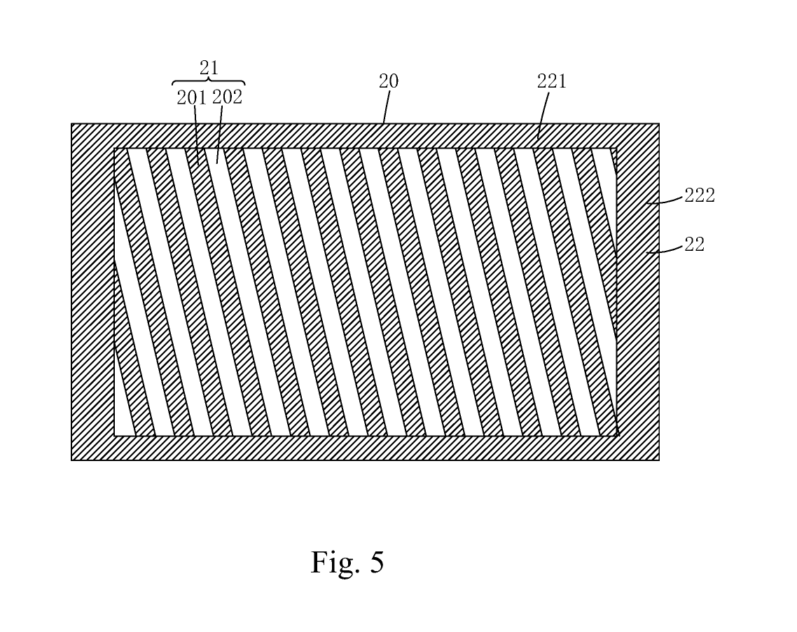

As shown in FIGS. 4 and 5, the metal wire grid units 21, the metal strips 201 and the strip-shaped spaces 202 are all of a linear form and parallel to each other. The metal strips 201 and the strip-shaped spaces 202 are both perpendicular to any one side of the metal light-shielding frame 22 or are both inclined to any one side of the metal light-shielding frame 22.

Specifically, as shown in FIG. 3, the metal wire grid polarizer 60 further comprises a transparent base plate 11 arranged under the dielectric layer 10. The transparent base plate 11 has a thickness of 10-1000 nm.

In the above-described metal wire grid polarizer, a metal light-shielding frame is arranged on an outer circumference of the polarization zone so as to provide an effect of shielding peripheral light leakage when the metal wire grid polarizer is used to substitute an upper polarizer of a liquid crystal display device so as to help reduce a width of a light-shielding zone on a periphery of a touch screen to facilitate bezel narrowing of the liquid crystal display.

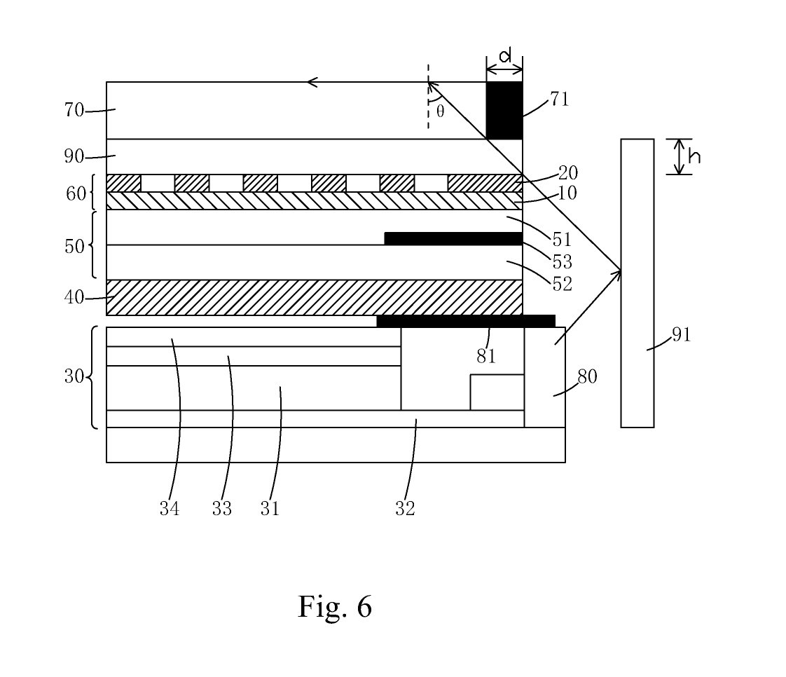

Referring to FIG. 6, the present invention also provides a liquid crystal display device, which comprises, arranged in sequence from bottom to top, a backlight module 30, a lower polarizer 40, a liquid crystal display panel 50, a metal wire grid polarizer 60, and a touch screen 70.

As shown in FIGS. 3-5, the metal wire grid polarizer 60 comprises a dielectric layer 10 and a metal layer 20 arranged on the dielectric layer 10. The metal layer 20 comprises a plurality of metal wire grid units 21, which are sequentially arranged side by side, and a metal light-shielding frame 22 arranged along an outer circumference of the plurality of metal wire grid units 21. The metal wire grid units 21 each comprise a metal strip 201 and a strip-shaped space 202 arranged at one side of the metal strip 201. The plurality of metal wire grid units 21 provides a function of polarization, while the metal light-shielding frame 22 provides a function of shielding light.

In the metal wire grid polarizer 60, the plurality of metal wire grid units 21 collectively form a polarization zone, which allows polarized light having a polarization direction perpendicular to the metal strips 201 to transmit and reflects polarized light having a polarization direction parallel to the metal strips 201 in order to achieve the function of polarization. The metal light-shielding frame 22 provides the function of shielding light and helps prevent light leakage at a periphery of a liquid crystal display device so as to facilitate bezel narrowing of the liquid crystal display device.

Specifically, the metal light-shielding frame 22 is connected to two ends of each of the plurality of metal strips 201 of the plurality of metal wire grid units 21. Preferably, the metal light-shielding frame 22 and the plurality of metal wire grid units 21 are integrally formed as a unitary structure.

Specifically, the metal wire grid units 21 each have a width of 20-500 nm, and the metal strip 201 has a width that is of a ratio of 0.1-0.9 of the width of the metal wire grid units 21. The metal strips 201 have a thickness of 10-500 nm. The metal light-shielding frame 22 has a thickness that is identical to the thickness of the metal strips 201.

Specifically, the metal layer 20 is formed of a material that comprises a metal material having a relatively large imaginary part of refractive index, such as one of multiple ones of aluminum, silver, and gold.

Specifically, the dielectric layer 10 has a thickness of 10-1000 nm.

Specifically, the dielectric layer 10 is formed of a material comprising one or multiple ones of silicon dioxide, silicon monoxide, magnesium oxide, silicon nitride, titanium oxide, and tantalum pentoxide.

Specifically, the metal light-shielding frame 22 is a rectangular frame, which comprises two first metal bands 221 that are opposite to each other and two second metal bands 222 that are respectively connected to two ends of each of the two first metal bands 221. The first metal bands 221 and the second metal bands 222 have thicknesses of 0.1-1 mm.

As shown in FIGS. 4 and 5, the metal wire grid units 21, the metal strips 201 and the strip-shaped spaces 202 are all of a linear form and parallel to each other. The metal strips 201 and the strip-shaped spaces 202 are both perpendicular to any one side of the metal light-shielding frame 22 or are both inclined to any one side of the metal light-shielding frame 22.

Specifically, as shown in FIG. 3, the metal wire grid polarizer 60 further comprises a transparent base plate 11 arranged under the dielectric layer 10. The transparent base plate 11 has a thickness of 10-1000 nm.

Specifically, the metal wire grid polarizer 60 is arranged such that the side that carries the metal layer 20 or the side that carries the dielectric layer 10 is set to face the liquid crystal display panel 50. In case that the metal wire grid polarizer 60 is arranged to have the side thereof that carries the dielectric layer 10 face the liquid crystal display panel 50, an upper substrate 51 of the liquid crystal display panel 50 may also serve as the transparent base plate 11 (as shown in FIG. 6).

The lower polarizer 40 can be a known polarizer and thus details will not be provided herein.

Specifically, the liquid crystal display device further comprises a mold frame 80 arranged on an outer circumference of the backlight module 30 and a light-shielding adhesive tape 81 that is adhesively attached to an edge of a lower surface of the lower polarizer 40, an edge of an upper surface of the backlight module 30, and a top surface of the mold frame 80. The mold frame 80 may support the backlight module 30.

Preferably, the light-shielding adhesive tape 81 comprises a black/white adhesive tape.

Specifically, the backlight module 30 comprises a light guide plate 31, a reflection film 32 arranged under the light guide plate 31, a diffusion film 33 arranged on the light guide plate 31, and a brightness enhancement film 34 arranged on the diffusion film 33.

Specifically, the liquid crystal display panel 50 comprises an upper substrate 51 and a lower substrate 52 that are opposite to each other, liquid crystal (not shown) arranged between the upper substrate 51 and the lower substrate 52, and a light-shielding layer 53 arranged on a peripheral area of the upper substrate 51 or the lower substrate 52.

Specifically, the upper substrate 51 and the lower substrate 52 are respectively a color filter substrate and a thin-film transistor array substrate; and the light-shielding layer 53 is a black matrix.

Specifically, the liquid crystal display panel 50 and the touch screen 70 are adhesively bonded by means of a bonding adhesive 90.

Specifically, the touch screen 70 has a peripheral area on which a light-shielding zone 71 is provided.

Further, the liquid crystal display device also comprises an intermediate frame 91 arranged at a lateral side of the liquid crystal display panel 50 and the backlight module 30. In case that the liquid crystal display device is used in a mobile phone, the intermediate frame can be a phone intermediate frame.

Due to the metal light-shielding frame 22 of the metal wire grid polarizer 60 so arranged, light reflected by the intermediate frame 91 is not allowed to project out through the upper substrate 51 of the liquid crystal display panel 50 and is only allowed to generate light leakage through the bonding adhesive 90. It is known that a minimum light shielding distance, d, of a periphery of the touch screen 70 must satisfy the formula d≥h*tan θ, and as shown in FIG. 6, in the above formula, h becomes the thickness of the bonding adhesive 90 so that the width d of the light-shielding zone 71 on the periphery of the touch screen 70 can be greatly reduced, making it possible to meet the needs for design of narrow bezel.

In summary, the present invention provides a metal wire grid polarizer and a liquid crystal display device. The metal wire grid polarizer of the present invention comprises a metal light-shielding frame arranged on an outer circumference of a polarization zone so as to reduce the potential risk of peripheral light leakage of a liquid crystal display device when the metal wire grid polarizer is used to substitute an upper polarizer of the liquid crystal display device, thereby helping reduce the width of a light-shielding zone on a periphery of a touch screen to facilitate bezel narrowing of the liquid crystal display device. The liquid crystal display device of the present invention uses the metal wire grid polarizer to substitute a conventionally-used upper polarizer to reduce the potential risk of peripheral light leakage thereby helping reduce the width of a light-shielding zone on a periphery of a touch screen to facilitate bezel narrowing of the liquid crystal display device.

Based on the description given above, those having ordinary skills of the art may easily contemplate various changes and modifications of the technical solution and technical ideas of the present invention and all these changes and modifications are considered within the protection scope of right for the present invention as defined in the appended claims.

What is claimed is:

1. A metal wire grid polarizer, comprising a dielectric layer and a metal layer arranged on the dielectric layer, the metal layer comprising a plurality of metal wire grid units sequentially arranged side by side and a metal light-shielding frame arranged along an outer circumference of the plurality of metal wire grid units, the metal wire grid units each comprising a metal strip and a strip-shaped space arranged at one side of the metal strip, the plurality of metal wire grid units providing a function of polarization, the metal light-shielding frame providing a function of shielding light.

2. The metal wire grid polarizer as claimed in claim 1, wherein the metal wire grid units each have a width of 20-500 nm; the metal strips each have a width that is of a ratio of 0.1-0.9 of the width of the metal wire grid units; and the metal strips have a thickness of 10-500 nm.

3. The metal wire grid polarizer as claimed in claim 1, wherein the metal layer is formed of a material comprising one or multiple ones of aluminum, silver, and gold; and the dielectric layer is formed of a material comprising one or multiple ones of silicon dioxide, silicon monoxide, magnesium oxide, silicon nitride, titanium dioxide, and tantalum pentoxide.

4. The metal wire grid polarizer as claimed in claim 1, wherein the metal light-shielding frame is a rectangular frame, which comprises two first metal bands that are opposite to each other and two second metal bands that are respectively connected to two ends of each of the two first metal bands, the first metal bands and the second metal bands having widths of 0.1-1 mm.

5. The metal wire grid polarizer as claimed in claim 1, wherein the metal light-shielding frame is connected to two ends of each of the metal strips of the plurality of metal wire grid units; and the metal light-shielding frame and the plurality of metal wire grid units are integrally formed as a unitary structure.

6. A liquid crystal display device, comprising, in sequence from bottom to top, a backlight module, a lower polarizer, a liquid crystal display panel, a metal wire grid polarizer, and a touch screen;
wherein the metal wire grid polarizer comprises a dielectric layer and a metal layer arranged on the dielectric layer, the metal layer comprising a plurality of metal wire grid units sequentially arranged side by side and a metal light-shielding frame arranged along an outer circumference of the plurality of metal wire grid units, the metal wire grid units each comprising a metal strip and a strip-shaped space arranged at one side of the metal strip, the plurality of metal wire grid units providing a function of polarization, the metal light-shielding frame providing a function of shielding light.

7. The liquid crystal display device as claimed in claim 6, wherein the metal wire grid units each have a width of 20-500 nm; the metal strips each have a width that is of a ratio of 0.1-0.9 of the width of the metal wire grid units; and the metal strips have a thickness of 10-500 nm.

8. The liquid crystal display device as claimed in claim 6, wherein the metal layer is formed of a material comprising one or multiple ones of aluminum, silver, and gold; and the dielectric layer is formed of a material comprising one or multiple ones of silicon dioxide, silicon monoxide, magnesium oxide, silicon nitride, titanium dioxide, and tantalum pentoxide.

9. The liquid crystal display device as claimed in claim 6, wherein the metal light-shielding frame is a rectangular frame, which comprises two first metal bands that are opposite to each other and two second metal bands that are respectively connected to two ends of each of the two first metal bands, the first metal bands and the second metal bands having widths of 0.1-1 mm.

10. The liquid crystal display device as claimed in claim 6 further comprising a mold frame arranged on an outer circumference of the backlight module, a light-shielding adhesive tape that is adhesively attached to an edge of a lower surface of the lower polarizer, an edge of an upper surface of the backlight module, and a top surface of the mold frame, and an intermediate frame arranged at a lateral side of the liquid crystal display panel and the backlight module;
wherein the liquid crystal display panel comprises an upper substrate and a lower substrate that are opposite to each other, liquid crystal arranged between the upper substrate and the lower substrate, and a light-shielding layer arranged on a peripheral area of the upper substrate or the lower substrate; and
the touch screen has a peripheral area on which a light-shielding zone is provided.

11. A liquid crystal display device, comprising, in sequence from bottom to top, a backlight module, a lower polarizer, a liquid crystal display panel, a metal wire grid polarizer, and a touch screen;
wherein the metal wire grid polarizer comprises a dielectric layer and a metal layer arranged on the dielectric layer, the metal layer comprising a plurality of metal wire grid units sequentially arranged side by side and a metal light-shielding frame arranged along an outer circumference of the plurality of metal wire grid units, the metal wire grid units each comprising a metal strip and a strip-shaped space arranged at one side of the metal strip, the plurality of metal wire grid units providing a function of polarization, the metal light-shielding frame providing a function of shielding light;
the liquid crystal display device further comprising a mold frame arranged on an outer circumference of the backlight module, a light-shielding adhesive tape that is adhesively attached to an edge of a lower surface of the lower polarizer, an edge of an upper surface of the backlight module, and a top surface of the mold frame, and an intermediate frame arranged at a lateral side of the liquid crystal display panel and the backlight module;
wherein the liquid crystal display panel comprises an upper substrate and a lower substrate that are opposite to each other, liquid crystal arranged between the upper substrate and the lower substrate, and a light-shielding layer arranged on a peripheral area of the upper substrate or the lower substrate; and
the touch screen has a peripheral area on which a light-shielding zone is provided;
wherein the metal layer is formed of a material comprising one or multiple ones of aluminum, silver, and gold; and the dielectric layer is formed of a material comprising one or multiple ones of silicon dioxide, silicon monoxide, magnesium oxide, silicon nitride, titanium dioxide, and tantalum pentoxide.

12. The liquid crystal display device as claimed in claim 11, wherein the metal wire grid units each have a width of 20-500 nm; the metal strips each have a width that is of a ratio of 0.1-0.9 of the width of the metal wire grid units; and the metal strips have a thickness of 10-500 nm.

13. The liquid crystal display device as claimed in claim 11, wherein the metal light-shielding frame is a rectangular frame, which comprises two first metal bands that are opposite to each other and two second metal bands that are respectively connected to two ends of each of the two first metal bands, the first metal bands and the second metal bands having widths of 0.1-1 mm.
